(19) United States
(12) Patent Application Publication
(10) Pub. No.: US 2007/0055478 A1
(43) Pub. Date: Mar. 8, 2007

(54) System and method for active data protection in a computer system in response to a request to access to a resource of the computer system

(75) Inventor: Daniele Perazzolo, Camponogara (IT)

Correspondence Address: DAVIDSON BERQUIST JACKSON & GOWDEY LLP, 4300 WILSON BLVD., 7TH FLOOR, ARLINGTON, VA, 22203, US

(73) Assignees: Daniele Perazzolo, Camponogara (IT); Francesco Garelli, Albignasego (IT)

(21) Appl. No.: 11/412,863

(22) Filed: Apr. 28, 2006

(30) Foreign Application Priority Data
Apr. 29, 2005 (IT) TO2005A000289

(51) Int. Cl. G21C 17/00

(52) U.S. Cl. 702/182

(57) ABSTRACT

System and method for data active protection in a computer system in the ambit of the access to a resource available in this computer system. That method applies to at least one resource the users of the system can access, and consists of a data protection profile that contains a set of data to protect, access conditions set in advance, protection actions defined to make safe the data listed in the data set. After an access request to a resource done by a user, the system collects the information that is used in the access request to the resource, realizes the protection profile related to the resource, verifies if the access information due to the access request satisfies one or more access conditions that are defined in the protection profile, and if one or more access conditions are satisfied by the access information, the system performs the protection actions with the aim of making the data listed in the data set not accessible.

This invention concerns a method for active protection of the data in a computer system in the ambit of an access request to a resource available in this computer system.

### BACKGROUND OF THE INVENTION

In any computer system, such as a single computer or a computer network, the access control is really important in order to guarantee the security, the integrity and the discretion of the data against any access from unauthorized users.

In the text that follows, the term “resource” describes:

the information or data stored in a file or a folder

or any software a user can utilize or that can be implemented in the computer system

or, generally speaking, any software or hardware of the computer system available to users.

Common computers, such as personal computers, contain often sensitive and personal information that are normally protected by access control systems at user level.

During last years, the grown of computer networks and of the correspondent services offered to users, together with the increasing popularity of notebooks, has emphasized the need for the protection of sensitive data and information.

In particular, communication networks allow access and sharing of data for an unlimited number of users, and so doing, they can really reduce the security level of the data accessible from the computers, directly or indirectly connected to these networks. On the other hand, the usage of notebooks, which are liable to thefts and loss, definitely increases the risk of unauthorized accesses and data loss in respect to more traditional computers.

With the aim of protecting the sensitive data stored in computers, many enhancements have been done in the access control systems. These systems normally respond to an access request to a resource from a user with a procedure that takes place in two phases: in the first phase, usually called “authentication”, the system tries to identify the user that requested access to the resource; in the second phase, usually called “authorization”, the system checks whether the identified (i.e. authenticated) user has the required rights to access the resource.

In detail, during the authentication, the computer access control system asks the user to insert his credentials, which normally consist of a identification code (UserId) and a password, and verify these credentials are valid and correct.

If the authentication completes successfully, the system can verify if the access credentials imply the rights to access the requested resources, and depending on the result of the check, it can allow or deny the access to the resource.

As an example that better explains the problem, consider the scenario in which a website offers basic information to an anonymous user, private and detailed information to users that made a “standard” subscription, even deeper details to users with a “premium” subscription. Whenever a user requests access to private information, the control system has to check that the request comes from a user with the proper subscription by applying the authentication and the authorization. The authentication checks the identity of the user that made the request usually by asking the access credentials, in term of UserID and password, and by verifying the credentials are correct and valid. If the authentication completes successfully, i.e. if the user is identified, the system moves to the authorization phase and tries to verify that the user has the required access rights; in the example, the system checks whether the user has a subscription that allows to get the requested information.

Another scenario is a local access network (LAN) that makes available any resource or service (e.g file, directory, . . . ) and includes an access control; in such a case the same procedure is applied to the access or service request coming from a specific user.

Furthermore, regardless of the access to a network, any computer usually manages the access to its local resources, such as the local desktop, the directories, the files, the software, the installed devices . . . , in order to assure a safe use to many local users by applying enhanced procedures for the authentication and authorization phased already described.

Unfortunately, those access control systems suffer from providing only a passive control that can not guarantee a satisfying level of security against many failed access attempts or other conditions that may produce a violation of the data privacy.

After a sequence of failed access attempts to a resource, those access systems can disable the credentials used in the access request, can log the problem into a journal file, and can send a notification message to the computer administrator. These actions do not offer a comprehensive protection because the data is not removed from the physical device and is still available in the computer system.

### SUMMARY OF THE INVENTION

This invention aims to:
define a method that assures a complete protection of data in case of access requests to a resource stored in a computer system.
define a software and a process that implement this method
define the computer system where this process can work.

In detail this invention describes a method for active data protection, a software, a process, and a computer system, as described in the attached claims.

### BRIEF DESCRIPTION OF THE DRAWINGS

The next paragraphs introduce an example of this invention with the support of the figures as follows:

FIG. 1 shows the structure of a computer system

FIG. 2 shows a data protection profile for the computer system in FIG. 1

FIG. 3 shows a second data protection profile for the computer system in FIG. 1

FIGS. 4a and 4b show a flow chart of the process that guarantee an active data protection, as defined in this invention.

### DETAILED DESCRIPTION OF THE INVENTION

This invention allows to define a data protection profile, which includes one or more access conditions for at least one resource available in the computer. When one of those conditions occurs, this invention allows to perform automatically one or more protection actions that make safe some of the data stored in the computer.

For instance, the protection actions can include the removal, overwrite and encryption of the data in the computer in order to make such data inaccessible or useless.

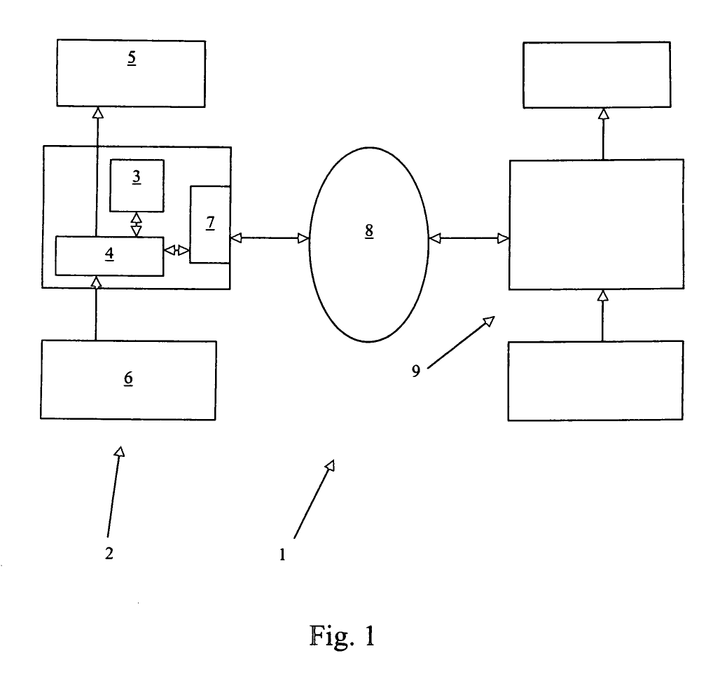

FIG. 1 shows a computer system 1 that includes at least a computer (e.g. a server, a workstation or a notebook) and contains a storage unit 3 and a processing unit 4.

Furthermore, the computer 2 can optionally contain an output device 5 (e.g. a monitor), an input device 6 (e.g. a keyboard), and a network device 7 that allows information exchange between the computer 2 and the remote devices 9 that can access to the same network (e.g. other computers, printers, storage units).

The network 8 can be a wide area communication system (e.g. Internet), a local access network (LAN), or any other system that offers data exchange among connected devices.

The processing unit 4 is a microprocessor that can perform all the operations to manage a proper, access control (authentication and authorization) in response to an access request from an expected user and depending on the user credentials. This microprocessor can also perform appropriate actions to protect data and other information in the computer 2, as defined in this invention and better explained in the paragraphs that follow.

The access credentials can include a user identification code, namely UserID, and a Password; they are often inserted into the computer 5 by using an input device 6 (i.e. a local access to the resource) or by using a network device 7, which receives the credentials from a remote computer connected to the network 8 (i.e. a remote access to the resource).

Anyway the access credentials can be input into the processing unit 4 by using other methods and other devices, such as a card reader, biometrics devices that can recognize the iris, and fingerprints.

The storage unit 3 can be any non-transient memory device, e.g a hard disk, which can contain one or more resources, such as the information and the data stored in folders and file, or programs that can run in the computer 2.

The storage unit 3 also contains one or more protection profiles, each related to a resource and consisting of:
a set of data to protect;
one or more access conditions that need to be checked after an access request
one or more actions able to act on the data whenever expected access conditions occur.

Each protection profile can be set up in a configuration phase (not showed in the figures) before any access to the resources done by users.

In detail, the data can be of any nature and format; it can include files, folders, documents, e-mail addresses, e-mail messages, web browser cookies and history, credentials submitted during an access procedure to a computer network, data previously deleted but still present on the physical support (such as files deleted with traditional methods, or files placed in the desktop trash bin).

Such data can also include any information stored by the operating system, such as a list of registry keys or any system file stored in the unit 3.

The protection actions that act on the data can include:
the physical and permanent removal of data;
one or more overwrites with random or predefined patterns, such as binary ciphers;
data encryption using a standard cryptography algorithm, which would make such data meaningless without the correct secret key;
data move or copy from the storage unit 3 to another storage unit in the computer 5 or to a network 8.
The profile operations can also include one or more actions to prevent the access to the computer 2, such as the automatic shutdown repeated at each logon, or the complete deactivation or removal of the operating system installed in the computer 2.

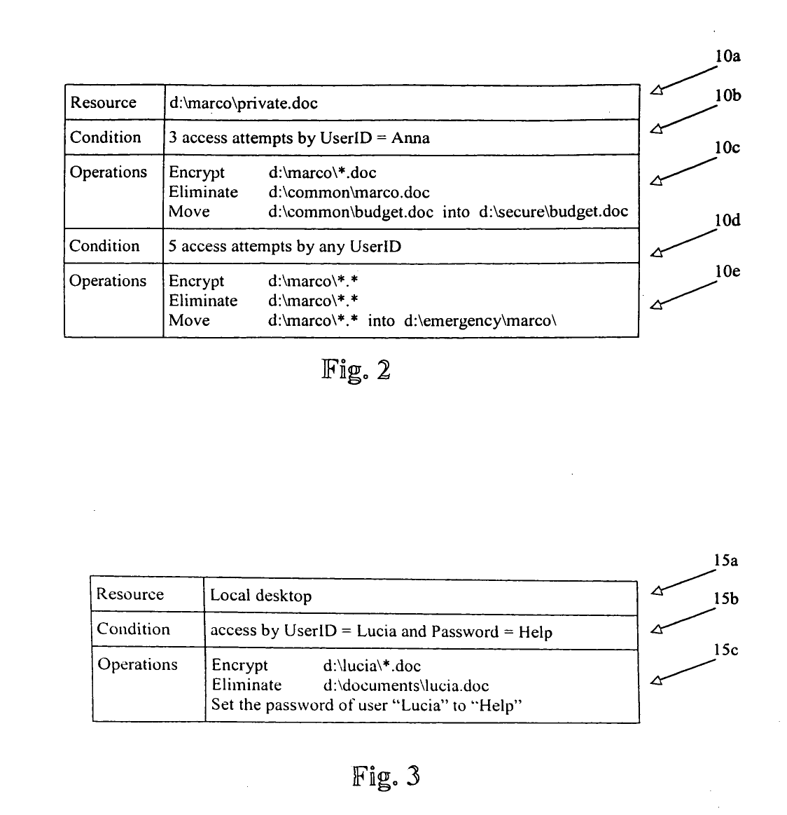

As example, the FIG. 2 shows a protection profile 10 that has been set up and saved in the storage unit 3.

The profile 10 protects the resource 10a (i.e. a file “privato.doc”, placed in a folder “marco”, stored in the disk “D:”), includes the conditions 10b and 10d to access the resource 10a, and includes the protection actions 10c and 10e, which are performed as soon as the corresponding conditions 10b and 10d occur.

In details, the first condition 10a occurs when a user fails the authentication phase with his UserID for three times; the second condition 10b occurs when any user performs five successive access attempts, either successfully or not. When the access condition 10b is verified, the system performs the actions 10c that include the encryption, deletion and relocation of a set of established data. When the access condition 10c is verified, the system performs the actions 10e, i.e. operations of encryption, file compression and relocation on a different set of data.

For instance, when the condition 10d occurs, the computer 2 encrypts all the files placed in a folder (in FIG. 2, the folder “marco” stored in the disk “D:”), compresses the content of a folder (in FIG. 2, all the files in the folder “marco” stored in the disk “D:”), and move the content of the folder to a different location in the storage unit (in the example, the system moves the compressed files from the folder “marco” to a subfolder “marco” of the folder “emergenza” in the same storage unit “D:”).

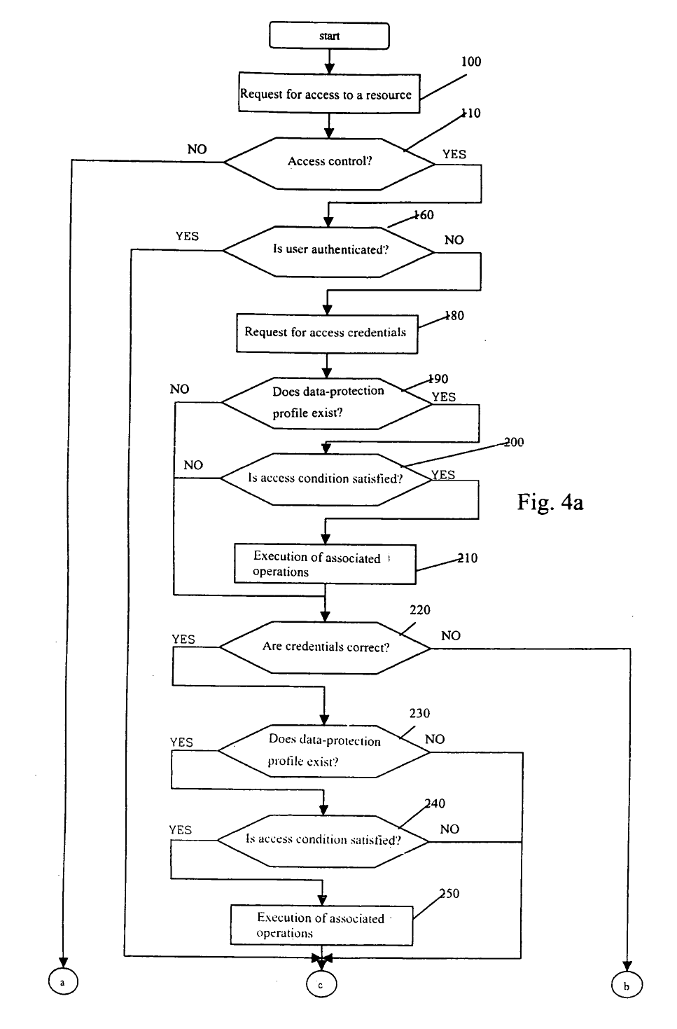

As a second example, FIG. 3 shows another protection profile 15 that has been set up and saved in the storage unit 3. This profile repeats the same features of the profile just described with few enhancements.

On computer start-up the user is normally required to provide his credentials (UserID and Password) to gain access to the Local Desktop, i.e. the environment which allows the local user to interact with system resources; the Local Desktop is normally a system resource subject to access control as well.

As the FIG. 3 shows, the profile 15 protects the resource 15a, i.e. the Local Desktop of the computer, and includes the condition 15b. This condition occurs when the access credentials match with a pre-established UserId (in FIG. 3, “Lucia”) and Password (in FIG. 3, “Help”). Finally the profile defines the actions 15c that include the encryption of the files placed in a folder (in FIG. 3, the folder “lucia”), the removal of the files placed in a different folder (in FIG. 3, the subfolder “lucia” in the folder “documenti” stored in the unid “d:”), and the setting of a new access password, specified in the profile configuration.

As a result, a protection profile that monitors the Local Desktop allows setting an emergency password to use in place of the original password when a danger condition requires a proper data protection.

For example, if an offender forces a user to supply his credentials, the user can provide his UserId and the emergency Password; the offender would successfully access the system, but would have no access to the data defined in the protection profile, because the actions 15c would make such data inaccessible and would change the original password with the emergency one.

The system applies each protection profile by using the information collected during the access control procedure, which includes the authentication and authorization phases.

Typically, such information is classified in three areas:
The first area includes information provided directly or indirectly by the user, such as credentials, the required access type, the resource name, the access time, and the IP address of the computer where the query comes from if the request goes through the network 8.
The second area includes information related to the authentication process, such as the rightness of the supplied credentials, further information about the account if the authentication was successful or the reason of the failure if the authentication failed, and other information concerning the internal state of the authentication process.
The third area includes information related to the authorization process, such as the chance to satisfy the query; the reason for a possible denied access and other information concerning the internal state of the authorization process.

This information is gradually acquired and compared with the conditions as defined in each protection profile for the resource the query relates to. Whenever the collected information matches one or more conditions in the profile, the processing unit 4 performs the implied actions to protect the discretion of the data stored in the computer 2.

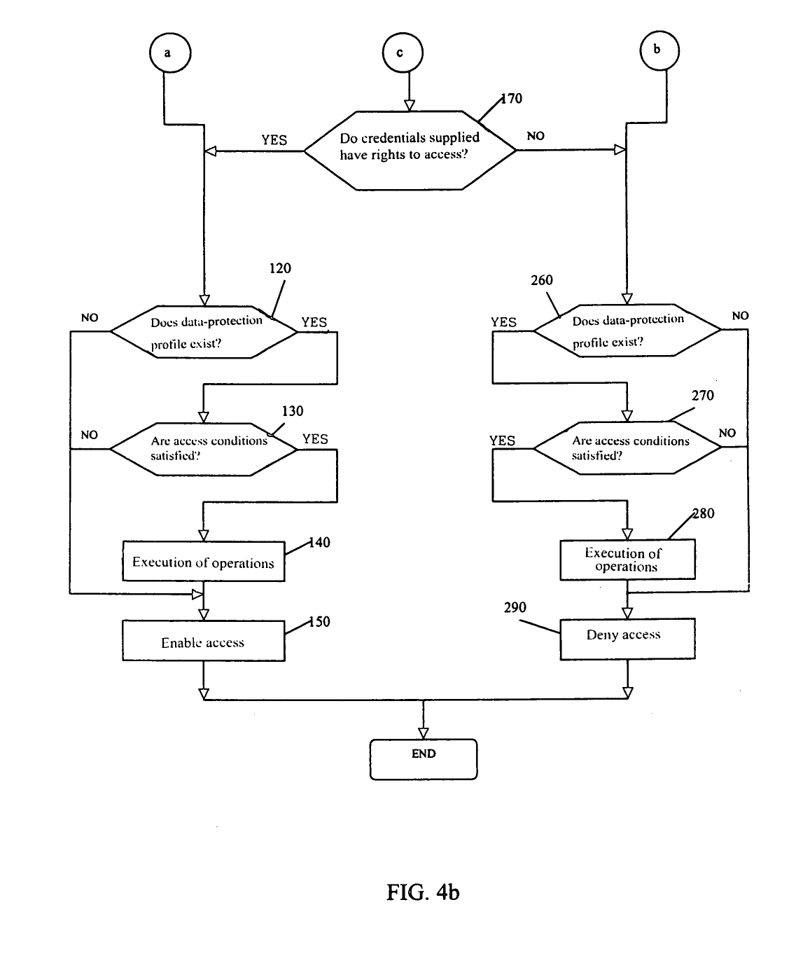

FIGS. 4a and 4b show a flow chart that details the active protection of the system 1 by using the process described in this invention and realized with an access control program installed in the processing unit 4.

To make the description easier, the next examples focus on “local” access to a file of a folder placed in the storage unit 3; anyway what said is also valid for a “remote” access through a computer network.

As shown in FIG. 4, whenever the user requests access to a resource (block 100) placed in the storage unit 3, the system verifies if the resource needs an access control (block 110), because the resource can allow only a limited set of operations for the user or group of users; for instance, the user can have the rights to read the file but not the rights to modify it.

If the resource does not require an access control and therefore is accessible without constraints by any user (exit NO from block 110), the system anyway allows the access after a sequence of further checks, as showed in FIG. 4b.

In details, the system checks whether a data protection profile exists that is related with the requested resource (block 120), and in such a case (exit SI from block 120), the system verifies if the access information collected so far satisfies one or more access conditions, as defined in the data protection profile (block 130). For instance, the access information can include the number of failed access attempts or the type of access that has been requested (e.g. read-only access or read-write access). In such a case, the access conditions would match when the number of access attempts equals a pre-established threshold, or when the type of access corresponds to one previously defined (read-only or read-write access). If the access conditions are satisfied (exit SI from block 130), the system applies the protection actions listed in the data protection profile to the data specified in the data set, and then the access control system lets access to the resource (block 150).

If a data protection profile for the resource does not exist (exit NO from block 120) or the access conditions of all the protection profiles are not satisfied (exit NO from block 130), the access control procedure allows access to the resource (block 150).

If the resource needs an access control, and therefore it can be accessed by the users with some constraints (exit SI from block 110), the access to the resource is allowed depending on the result of the tests and operations showed in FIG. 4a.

In detail, the system verifies if the user has been previously authenticated (block 160) and if therefore the access information includes the user's credentials and other authentication data. If the authentication has been performed with success in a previous request, the access control system performs the authorization phase, which basically checks whether the user's credentials imply the rights to access the resource with the privileges the user needs (block 170) (FIG. 4b). If the authentication has never been done (exit NO from block 160), the access control system asks the user to insert the access credentials, e.g. the UserID and the Password (block 180).

Before checking that the credentials are valid, the system looks for a data protection profile for the resource (block 190), and in such a case (exit SI from block 190), the system checks whether the access information collected so far (including the credentials just inserted) satisfies one or more access conditions defined in the that profile (block 200). If the access conditions match (exit SI from block 200), the system performs the protection actions as listed in the data set that the protection profile contains. Afterward the access control system completes the user authentication by checking if the access credentials are correct (block 220). Instead, if there is no data protection profile for that resource (exit NO from block 190) or if in all the profiles for that resource the access conditions are not verified (exit NO from block 200), the access control system performs the user authentication as soon as the user inserts the credentials.

Checking for a protection profile, where at least an access condition matches with the collected access information (block 190 and 200), before the user's authentication, allows to filter the request if for instance, the user used an emergency password as previously described.

If the user's authentication is successful, i.e. if the access credentials are valid (exit SI from block 220), the system verifies if a data protection profile for the resource exists (block 230) and in such a case (exit SI from block 230), the system verifies if the access information collected so far (including the credentials and the authentication result) satisfy one or more access conditions, as defined in the data protection profile (block 240).

If the access conditions match (exit SI from block 240), the system performs the protection actions as listed in the data set that the protection profile contains (block 250). Afterward the access control system checks whether the user credentials imply the rights to access the resource using the mode requested by the user (block 170). Instead, if there is no data protection profile for that resource (exit NO from block 230) or if in all the profiles for that resource the access conditions are not verified (exit NO from block 240), the access control system verifies the user rights to access as soon as the user inserts the credentials.

As shown in FIG. 4a, if the access credentials include the right to access the resource using the requested mode (exit SI from block 170), the access occurs as described previously and as showed in FIG. 4b (blocks 120, 130, 140 and 150).

If the access credentials do not pass the authentication and the authorization, i.e. either the credentials are wrong (exit NO from block 220) (FIG. 4a) or they don't imply the right to access the resource in the requested mode (exit NO from block 170), the system denies the access to the file as showed in FIG. 4b.

In detail, the system checks whether a data protection profile exists that is related to the requested resource (block 260) and, if the data protection profile exists (exit SI from block 260), the system checks whether the access information, which have been acquired so far and includes the access credentials and/or pieces of information related with the user's authentication, satisfies one or more access conditions defined in the data protection profile (block 270). If the access conditions are satisfied (exit SI from block 270), then the protection actions are executed by the data protection profile (block 280) on the data recorded in the data list and, subsequently, the access control procedure denies the access to the resource (block 290).

If a data protection profile for the resource doesn't exist (exit NO from block 260) or the access conditions of the data protection profile are not satisfied (exit NO from block 270), the access control procedure denies likewise the access to the resource (block 290).

The data protection method we have just described is extremely convenient because it is able to check many different situations associated to prohibited or partially authorized access requests, in order to automatically enable the data protection, preventing any possibility of access to the data for unauthorized users and increasing therefore the data security. In fact, this data protection method has an active behaviour towards the data to protect, because it directly acts on the data by using the access information it has acquired during the authentication and authorization phases, on which the access control is based.

The computer system 1 is also extremely flexible, versatile and easy to set up, because it allows to define in detail the access conditions to check at the time of the user's identification, to list the data to protect and to set in detail the protection actions that make useless the data listed in the data protection profile, in case of deceitful access. In detail, the protection operations can include the encryption, move and removal of data, and are autonomously carried out by the computer 2.

The computer system 1 can successfully work even when the system is placed in a network 8 and the authentication and/or authorization processes are committed, from the computer 2 where the request access from, to one or more computers that are in the network 8, are programmed to play this role and are not the one that checks the accesses. Moreover, in these scenarios the data protection profiles could be stored in one or more computers that are in the network, are programmed to contain them, and are not the one which checks the accesses. The computer system 1 gathers the access information sent to the computers in charge of the authentication and/or authorization processes and carries out the controls and operations of the method of active data protection, as defined in this invention.

Moreover, the computer system 1 can successfully work even when the authentication and authorization systems are many, maintaining the properties of the traditional access control systems and extending their features and their control range and effect. For example, if a user accesses a computer and afterwards launches a program that requires, in order to work, a special authorization through the insertion of special UserID and Password, the authentication and authorization system, which the program must implement inside, can be extended with the method of active data protection as defined in this invention.

The active data protection defined in this invention is useful also to protect a person from an offender who wants to get a computer data by forcing the user to give his access credentials. In fact, the user can just create a data protection profile for the resource “Local Desktop” (very common in personal computers now on the market), he can to define an access condition that includes his UserID and an emergency Password (different from the normal access Password) and he can set up protection actions, including the replacement of the normal access Password with the emergency one, which make data inaccessible or unusable. As a result, the offender would be able to access to the computer, but he would cause the immediate protection of the data.

Italian Patent Application No. TO2005A000289, filed Apr. 29, 2005, is herein incorporated by referenced in its entirety.

1. A method for active data protection in a computer system (1) in response to a request for access to an available resource in the computer system (1) itself and accessible by a user; said method being characterized in that it comprises the steps of:
defining, for said resource, a data-protection profile comprising: at least one list of data to be protected; at least one condition of access to said resource; and at least one protection operation to be carried out on the data indicated in said data list so as to render them unusable; and in response to a request for access (100) to said resource, said method comprising the steps of:
acquiring (110, 170, 180, 220) access information regarding said request for access;
identifying (120, 190, 230, 260) the data-protection profile associated to said resource;
verifying (130, 200, 240, 270) whether said access information satisfies said condition of access specified in said data-protection profile associated to said resource;
in the case where said access information satisfies said condition of access, carrying out (140, 210, 250, 280) said protection operation so as to render said data unusable.

2. The method according to claim 1, characterized in that said protection operation comprises at least one operation of elimination of said data, and/or one operation of encryption of said data.

3. The method according to claim 1, characterized in that said protection operation comprises an operation of overwriting of said data according to a given algorithm, and/or an operation of moving said data into a different memory location of said computer system (1).

4. The method according to claim 1, characterized in that said access information comprises access credentials.

5. The method according to claim 1, characterized in that said access information comprises information indicating the outcome of an authentication of the user requesting access to said resource.

6. The method according to claim 1, characterized in that said access information comprises information indicating the outcome of an authorization for access to said resource.

7. The method according to claim 1, characterized in that said access information comprises information indicating whether said resource is subject to an access check.

8. The method according to claim 1, characterized in that said access information comprises a time indication of when said request for access was made.

9. The method according to claim 1, characterized in that it further comprises the step of verifying (110) whether said resource is subject to an access check.

10. The method according to claim 1, characterized in that it further comprises the step of authenticating (220) the user requesting access to said resource.

11. The method according to claim 1, characterized in that it further comprises the step of authorizing (170) access to said resource.

12. The method according to claim 10, characterized in that it comprises the step of denying (290) access to said resource in the case where the user has not been authenticated nor authorized.

13. The method according to claim 9, characterized in that it comprises the step of enabling (150) access to said resource in the case where the user has been authenticated and authorized, or in the case where said resource is not subject to an access check.

14. The method according to claim 9, characterized in that it comprises the step of storing said data-protection profile in a computer different from the one that performs said access check.

15. The method according to claim 10, characterized in that said authentication and/or said authorization are performed by a computer different from the one that performs said access check.

16. A computer product which can be loaded into the memory of a processing device (4) and is designed for implementing, when run, the method according to claim 1.

17. A processing device comprising a memory in which a computer product is loaded designed for implementing, when run, the method according to claim 1.

18. A computer system comprising at least one processing device (4) according to claim 17.
